(19) United States
(12) Patent Application Publication
(10) Pub. No.: US 2013/0214681 A1
(43) Pub. Date: Aug. 22, 2013

(54) METHOD FOR OPERATING A GAS DISCHARGE LAMP OF A MOTOR VEHICLE HEADLAMP

(71) Applicants: Dominik Neeser, Reutlingen (DE); Christian Johann, Reutlingen (DE)

(72) Inventors: Dominik Neeser, Reutlingen (DE); Christian Johann, Reutlingen (DE)

(73) Assignee: AUTOMOTIVE LIGHTING REUTLINGEN GMBH, Reutlingen (DE)

(21) Appl. No.: 13/822,389

(22) PCT Filed: Sep. 9, 2011
(86) PCT No.: PCT/EP2011/065600

§ 371 Date: May 8, 2013

(30) Foreign Application Priority Data
Sep. 16, 2010 (DE) 10 2010 045 584.9

(51) Int. Cl. H05B 41/16

(52) U.S. Cl. CPC H05B 41/16
USPC 315/82

(57) ABSTRACT

A method for operating a gas-discharge lamp (10) of a motor-vehicle headlamp comprises steps of operating the gas-discharge lamp (10) in a first operating mode at a comparatively higher power and alternating-current voltage and in a second operating mode in a temporally limiting manner at a comparatively lower power and direct-current voltage. When a switch is made from the first operating mode to the second operating mode, a polarity of the direct-current voltage is predefined depending on the respective polarities of the direct-current voltage in at least one previous operating phase of the second operating mode. A device or unit operates the gas-discharge lamp and controls a sequence of the method.

### CROSS-REFERENCE TO RELATED APPLICATIONS

This is a “national stage” application of International Patent Application PCT/EP2011/065600 filed on Sep. 9, 2011, which, in turn, is based upon and claims priority to German Patent Application 10 2010 045 584.9 filed on Sep. 16, 2010.

### BACKGROUND OF INVENTION

1. Field of Invention

The invention concerns a method for operating a gas-discharge lamp of a motor-vehicle headlamp as well as a control device for such operation.

2. Description of Related Art

Motor-vehicle headlamps are disposed in the front region of a vehicle and serve to illuminate the roadway in front of the vehicle. The gas-discharge lamp serves as a light source, the light of which is distributed in front of the headlamps and, in particular, on the driving surface by the headlamps in the form of a desired light distribution (such as that from a low-beam lamp distribution or a high-beam lamp distribution). Gas-discharge lamps feature a glass bulb filled with gas and in which at least two electrodes are located. By igniting a gas discharge, a light-emitting electric are is generated between the electrodes, which is maintained by a constant supply of electric power to the electrodes.

The control of the supply of electric power occurs by a control device (e.g., a control module). For this, the gas-discharge lamp is operated in a first operating state with a comparatively higher power level and AC voltage. The higher power level corresponds, for example, to the nominal capacity of the gas-discharge lamp. This power level is controlled by the control device and transferred thereto. The control and transference are accompanied by power loss (released in the control device in the form of heat), leading to a heating thereof and, thereby, leading to a thermal load to the control device. The thermal loads contribute to a thermal load to the control device resulting from the surroundings thereof. The control device is in the engine compartment or in the headlamp and, therefore, disposed in an environment in which temperatures exceeding 100° Celsius may occur.

Thermal loads can have a negative impact on the life expectancy of the control device when they exceed a normal level and, in extreme cases, may lead to a premature malfunction thereof. To prevent this, the gas-discharge lamps specified above are temporally limited in a second operating state with a comparatively lower power level and with DC voltage. The second operating state represents, with respect to the control device, a component-protection operating mode.

By the operation at a lower power level, the heating of the lamp is reduced. In the AC-voltage operation thereof, the power thereby can only be reduced to a comparatively less extent. An excessive reduction in the AC operation thereof leads to undesired instabilities of the electric arc, which can result in an electric are being extinguished.

In the DC-operating mode, in contrast, the power can be substantially reduced without having to accept the aforementioned instabilities. For gas-discharge lamps having a lower nominal capacity of 25 watts, it has been shown, for example, that the power in an AC-voltage operation thereof can be reduced to about 21 watts and in a DC-voltage operation to about 18 watts. From the greater reduction in the DC mode, a greater potential for limiting the heating of the control device itself is obtained.

The change from the first operating mode to the second operating mode normally occurs depending on a temperature of the control device and/or a power loss of the control device, wherein external factors (such as a current surrounding temperature and a current system voltage) may be taken into account.

It has been shown that gas-discharge lamps, which are frequently operated in a DC mode, malfunction with a greater probability than gas-discharge lamps operated less frequently in the DC mode. The protection from a thermal overload to the control device, therefore, would appear to be accompanied in the related art with an increase in the chance of a malfunction of the gas-discharge lamp.

With this background, an objective of the invention is to improve the known method and the known control device in this respect such that the protection of the control device from a thermal overload can be maintained and that, however, an increased chance of malfunction of the gas-discharge lamp thereby is simultaneously reduced.

### SUMMARY OF INVENTION

The invention overcomes disadvantages in the related art in a method for operating at least one gas-discharge lamp of a motor-vehicle headlamp. The method comprises steps of operating the at least one gas-discharge lamp in a first operating mode with a comparatively higher power level and AC voltage and in a second operating mode in a temporally limiting manner with a comparatively lower power level and DC voltage. A polarity of the DC voltage in changing from the first operating mode to the second operating mode is predetermined depending on the respective polarities of the DC voltage in at least one preceding operating phase of the second operating mode. The invention overcomes disadvantages in the related art also in a device or unit for the operation of the gas-discharge lamp and control of a sequence of the method.

The invention is distinguished in that a polarity of the DC voltage in a change from the first to the second operating mode is determined depending on the polarity of the DC voltage in at least one of the preceding operating phases of the second operating mode.

The invention is based on the realization that the known DC-operating mode can lead to a non-uniform burning of the electrodes, which increases the probability of a malfunction.

The invention is, therefore, based on the idea of defining the polarity of the electrodes in an operating mode in which the gas-discharge lamp is operated in the second operating mode with a DC voltage such that at least a substantially symmetrical distribution of the DC-voltage polarities over the course of numerous operating phases of the second operating mode is obtained at the electrodes of the gas-discharge lamp.

By the symmetrical distribution of the DC-voltage polarities, a uniform burning of the electrodes is obtained such that a “wear” threshold (at which point a malfunction must be anticipated) is reached, advantageously, at a later point in time with the invention. As a result, the second operating mode, which serves as a protection for the control device, can be maintained without having to accept a greater possibility of a malfunction of the gas-discharge lamp.

The method according to the invention makes use of a logic component for this in the control device and a non-volatile memory (for example, a microcontroller having an integrated data “EEPROM”). A history of the polarities for at least the last phase in the “DC voltage” mode is stored by the non-volatile memory (even after a “power ‘on’” reset of the control device) and can be processed by the integrated logic in the control device. A substantially uniform burning of the electrodes can be obtained by a reversal of the polarities in a subsequent DC-voltage operating phase over the entire life expectancy of the lamp. A stable lamp operation can, thereby, be ensured for the entire intended life expectancy of the gas-discharge lamp despite the reduced power level.

In the framework of an embodiment of the method, the respective polarities of the DC voltage [in comparison with the polarities in the previous DC-voltage operating phase (the second operating mode)], are reversed at the beginning of each new operating phase of the second operating mode. For this, the corresponding polarities used in a second operating mode are each stored in the non-volatile memory. With the next demand for the second operating mode, the opposite polarity for operating the gas-discharge lamp is selected by the integrated logic in the control device based on the stored polarity, and the corresponding information is overwritten in the non-volatile memory with the current polarity. This method is distinguished by the necessity of a very small non-volatile memory, wherein a memory component of one bit is sufficient.

In an alternative embodiment of the method, a temporal duration of each new operating phase in the second operating mode is determined, and the respective polarities of the DC voltage are symmetrically distributed over the course of numerous operating phases of the second operating mode. This embodiment depends on the storage of the actual duration of an operating phase of the second operating mode and the polarities occurring thereby with a suitable temporal resolution. This can, for example, be implemented in the logic such that a meter reading at the application of a first polarity is periodically increased and, upon applying a second polarity, is periodically decreased, wherein the polarities at the beginning of a DC-voltage operating phase are defined in each case such that the absolute value of the meter reading is reduced.

With short DC-voltage operating phases, it is possible [in that the gas-discharge lamps are operated successively with the same polarities to the electrodes during numerous DC-voltage operating phases (for example, at a higher meter reading obtained during a long DC-voltage operating phase)] to successively reduce the operating phases over the course of numerous successive DC-voltage operating phases. As a result, over the course of time, an alternating course of the polarities about the zero point or a base value of the meter reading is obtained. Via numerous operating phases in the second operating mode, a precisely symmetrical distribution of the polarities can be obtained thereby. The polarity of a current phase in the second operating mode is selected, in each case, according to the criteria of obtaining a balanced, symmetrical operation with positive and negative polarities. This method is, therefore, advantageously and substantially independent of the temporal distribution of external factors, which trigger in a phase in the second operating mode.

In an embodiment, a temporal duration of the operating phase in the second operating mode is monitored, wherein, upon exceeding an operating time period (defined as the maximum), the respective polarities of the DC voltage are reversed. As a result, a one-sided wear to the electrodes (electrode burning) in the gas-discharge lamp (as a result of the same polarity being applied over a long period of time in a single operating phase in the second operating mode) is prevented. The temporal duration is substantially determined by the structure of the gas-discharge lamp, the material of the electrodes, and the current electrical system such that a time dependent reversal of the polarities can occur thereby after a few minutes (e.g., 5 minutes). The temporal monitoring of the operating phases with uniformly applied polarities can be integrated in both of the embodiments specified above.

Other objects, features, and advantages of the invention are readily appreciated as it becomes more understood while the subsequent detailed description of embodiments of the invention is read taken in conjunction with the accompanying drawing thereof.

### BRIEF DESCRIPTION OF EACH FIGURE OF DRAWING OF INVENTION

The figures of the drawing depict in schematic form:

FIG. 1: a functional block diagram of a gas-discharge lamp with control-device functions necessary for the operation thereof;

FIG. 2: a functional block diagram of a control device from FIG. 1;

FIG. 3: a flow chart with a sequence of an embodiment of the method according to the invention;

FIG. 4: a time-dependent signal illustration for the sequence of the embodiment of FIG. 3;

FIG. 5: a flow chart with a sequence for another embodiment of the method according to the invention;

FIG. 6: a flow chart with a partial sequence for another embodiment of the method according to the invention;

FIG. 7: a temporally scanned depiction of a polarity applied to the gas-discharge lamp of FIG. 1 for illustrating the sequence of the embodiments of FIGS. 5 and 6;

FIG. 8: a signal depiction for the sequence of the embodiment of FIG. 5; and

FIG. 9: a signal depiction for the sequence of the embodiment of FIG. 6.

### DETAILED DESCRIPTION OF EMBODIMENTS OF INVENTION

The same reference numerals refer in the various figures to the same components or at least to components having the same function.

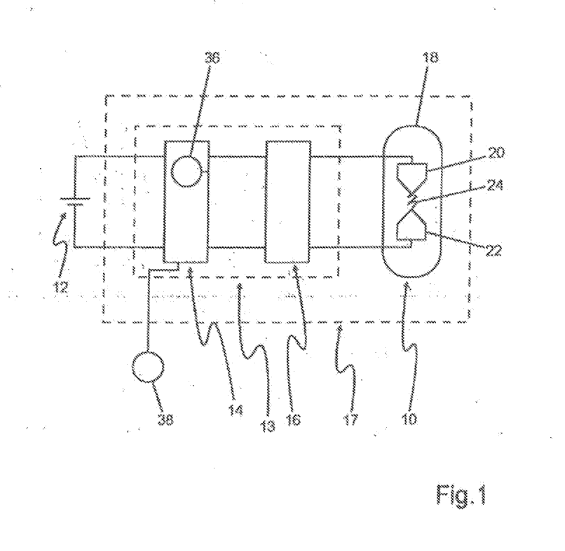

FIG. 1 shows a gas-discharge lamp 10 having a storage unit 12 for electric energy and a control unit. For this, the control unit is understood to be the structural unit with which the operation of the gas-discharge lamp 10 is controlled. The control unit can be implemented as a separate control device 14, which is connected to the gas-discharge lamp 10 by a separate ignition device 16. In an alternative embodiment, the control unit is a structurally integrated unit comprising a control device 14 and an ignition unit 16 in the form of a power-supply unit 13. It is also possible that the control unit is implemented as a complete module 17 in the form of a structurally integrated unit having a control device 14, an ignition device 16, and a gas-discharge lamp 10.

A first temperature gauge 36 is disposed in the interior of the control unit for determining the interior temperature of the control unit. Depending on the embodiment, the first temperature gauge 36 is disposed in the interior of the control device 14, the structural unit 13, or the complete module 17. FIG. 1 shows an embodiment in which the first temperature gauge 36 is disposed in the control device 14.

A second temperature gauge 38 is disposed in the exterior of the control unit by which the surrounding temperature of the control unit 13 can be determined. The temperature gauges 36, 38 can, for example, comprise temperature-dependent resistors or thermocouples.

The gas-discharge lamp 10 exhibits a glass bulb 18 filled with gas and at least two electrodes 20, 22. With the operation of the gas-discharge lamp 10, a gas discharge between the electrodes 20, 22 is ignited to form an electric arc 14 (emitting stable light) and maintained by a continuous supply of electric energy.

The electric energy is taken from the storage unit 12, which, in one embodiment of an energy-storage unit of an electrical system of a motor vehicle is, in particular, a vehicle battery.

The ignition device 16 provides an ignition voltage for igniting the gas-discharge lamp 10. The control device 14 serves to provide an input voltage for the ignition device 16 and an operating voltage for operation of the gas-discharge lamp 10. These voltages are generated by the control device 14 from the electrical system of the motor vehicle.

The control device 14 runs and monitors the gas-discharge lamp 10. It generates an intermediate voltage (approximately 1,000 volts) from the electrical system as an input voltage for the ignition device 16, which is then transformed by the ignition device to the intermediate voltage (approximately 25,000 volts). It generates also an operating voltage for the continuous operation of the gas-discharge lamp after the ignition of the electric arc 24.

Furthermore, the control device 14 causes the ignition device 16 to ignite the electric arc in the gas-discharge lamp 10, controls the power supply during the start-up phase of a cold gas-discharge lamp 10, and causes a power-regulated supply to the gas-discharge lamp 10 in its stationary operation. The control device 14 is furthermore, in an embodiment, configured to substantially compensate for effects caused by fluctuations in the electrical system in the control of the gas-discharge lamp 10. It, for example, the gas-discharge lamp 10 is extinguished due to an extreme voltage interruption in the electrical system, the control device 14 causes the ignition device 16 to immediately re-ignite the gas-discharge lamp 10.

During the transition from the deactivated state without an electric arc 24 to a state in which a stable light is generated, numerous phases can be distinguished, which are referred to as “ignition,” “acquisition,” and “start-up.” The normal operation with a stable burning electric arc 24 follows.

For the ignition, an ignition-voltage impulse is first applied to the electrodes. The ignition-voltage impulse is very short and leads to an ionization of the gas particles in the electric field between the electrodes. The level of the impulse-type ignition voltage for conventional commercial gas-discharge lamps for motor-vehicle headlamps lies between 20 and 30 kilovolts.

In a phase referred to as the “acquisition phase,” energy stored in a booster-condenser is used subsequently for accelerating the ionized gas particles to the extent that, by impact ionizations, an avalanche-like discharge breakthrough between the electrodes is obtained, which ignites the electric arc and maintains the electric arc. For this, the voltage of the previously charged booster condenser of about 400 volts is reduced to a burn voltage that can be set in a stable operating state. For lamps containing Hg (mercury), this is about 80 volts. Lamps without Hg are operated at a burn voltage of 43 volts. In general, it is the case that the burn voltage can lie between 30 volts and 120 volts, depending on the design of the lamp. The acquisition phase lasts, for example, a few hundred microseconds.

Following the acquisition, a start-up of the gas-discharge lamp occurs having a temporary DC-operating mode, which serves for the quick heating of the electrodes. A typical DC phase is between 20 and 80 milliseconds. A first DC phase is normally followed by a second DC phase of the same length with reversed polarities.

Following the DC-operating mode, the gas-discharge lamp is operated with an AC voltage having a frequency of 250 Hz to 800 Hz (in particular, about 400 Hz) and a burn voltage (dependent on the design of the lamp) between the two electrodes, which lies between 30 and 120 volts. For this, the lamp is first operated with an electrical power that is increased in relation to its nominal capacity. The operation with AC voltage serves, thereby, to limit a burning of the electrodes. This operation resulting from an AC voltage and the nominal capacity represents the first operating mode.

The control device 14 is furthermore, in an embodiment, configured to temporarily protect the gas-discharge lamp 10 from its own thermal load (of the control device), for operating with a limited power in a second operating mode (“component protection” mode), to reduce the temperature in the control device 14, or at least to limit an increase in temperature.

The control device must also ensure a secure or stable operation of the electric arc 24 in the gas-discharge lamp 10 with a lower power level and, in particular, prevent an interruption of the electric arc 24. For this reason, the gas-discharge lamp 10 is operated with a DC voltage (“DC voltage” mode) after the change in the operating mode from a normal operating mode to the power-reduced second operating mode. This “DC voltage” mode results in a stable operation of the electric are 24 even at a reduced power level. For this, a reduction of the power by approximately 25% is possible.

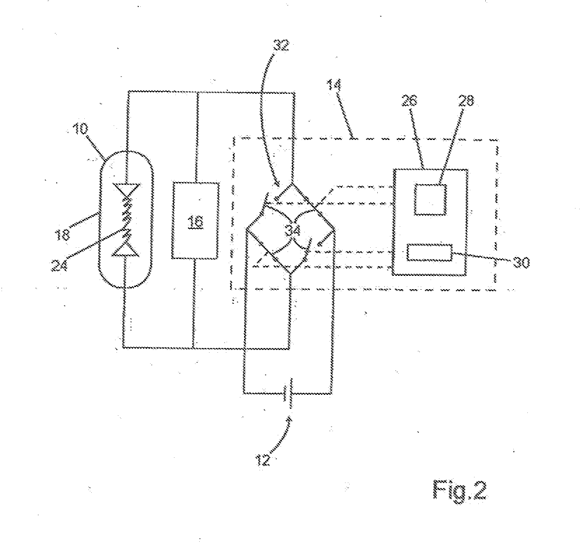

FIG. 2 shows, in particular, the control device 14 in a detailed depiction thereof. The control device 14 exhibits a computer unit 26 having a microprocessor 28 and an electronic-storage element 30, which is, in an embodiment, implemented as a non-volatile memory. The non-volatile memory 30 is a storage unit the store data of which also remain intact without a permanent energy supply. The control device 14 is configured for controlling a method for operating and igniting the gas-discharge lamp 10.

For the operation of the gas-discharge lamp 10 in the second operating mode (with DC voltage), the control device 14 furthermore exhibits a switchover device 32 for reversing the applicable polarities at the electrodes 20, 22 of the gas-discharge lamp 10.

The switchover device 32 comprises four switch elements 34, which can be activated via the computer device 26 using logical decisions made in the microprocessor 28. Through switchings of the switching elements 34 occurring in pairs, the corresponding polarities of the electrodes 20, 22 can be reversed. For this, switches lying opposite one another in FIG. 2 are placed in the same setting, respectively, wherein switches adjacent to one another are, in each case, switched synchronously in settings complementary to one another.

In the following, the sequences shall be explained for three embodiments of the method according to the invention for reversing the polarities at the electrodes 20, 22 of the gas-discharge lamp 10 with power-reduced DC voltage. As the starting point in each case, a current operation of the gas-discharge lamp 10 in its normal operating mode (i.e., with AC voltage) is assumed. Running criteria for the change from the normal operating mode to the power-reduced second operating mode are determined in the control device 14. This can, for example, occur via the signals from the temperature gauge 36 by which the internal temperature of the control device 14 is determined. Alternatively or in addition, this can occur via a determination of a power loss to the control device 13. The power loss can be determined, for example, from the internal temperature and the characteristic curves, which, for example, map a relationship of the power losses from known operating parameters in the control device 14 (such as current and voltage) to the electrodes 20, 22 of the gas-discharge lamp 10 or at corresponding outputs or measuring points of the control device.

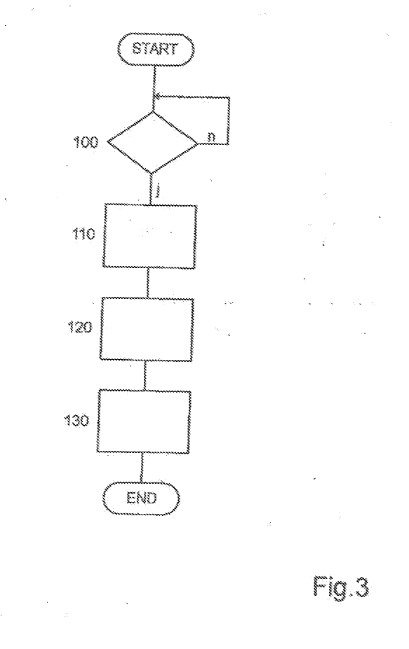

FIG. 3 shows a flow chart as an embodiment of a method according to the invention. In query 100, it is checked whether the criteria for a switching to a “component protection” mode with a reduced power level are fulfilled. For this, in one design, the determined values for the temperature and/or the power loss are compared with predetermined threshold values. External factors, such as a surrounding temperature of the control device 13, that can be determined via the temperature gauge 38 and/or a current electrical system voltage can be taken into consideration thereby.

The electrical-system voltage is either already known in the control device 14 or can be determined via a bus system of the motor vehicle, which connects numerous control devices and/or sensors such that a data exchange is possible. One example of a bus system of this type is the known “CAN” bus. With a reduced electrical-system voltage, the control device would set, for example, higher current levels in the regulation of the lamp power, which increases the heating of the control device. If an exceeding of the threshold value has been detected, a switching is made in the control device 14 to the power-reduced operating mode in the “DC voltage” mode.

For this, in step 110, a characteristic for the polarity is selected from the non-volatile memory, which, for example, was present at the electrode 20 in the last operating phase in the “DC voltage” mode. The non-volatile memory can be limited here to a single bit. Subsequently, in step 120, the electrodes 20, 22 of the gas-discharge lamp 10 are controlled with the reversed polarities and with an accordingly reduced power level using DC voltage. In step 130, a characteristic for a current polarity applied to the electrode 20 is saved in the non-volatile memory 30.

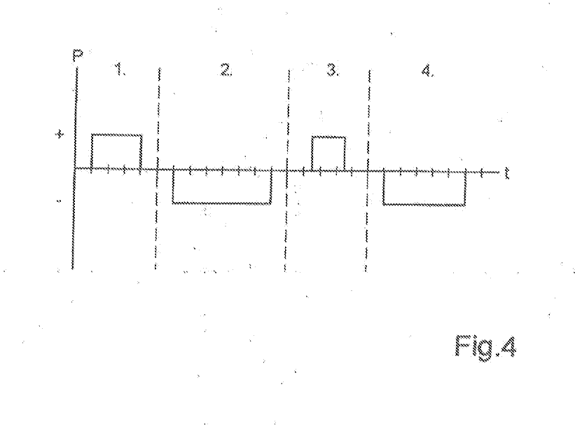

FIG. 4 shows a respective polarity (+/−), applied to the electrode 20 by four temporally different operating-phase durations, in the power-reduced second operating mode in the “DC voltage” mode. Operating phases in the normal operating mode with AC voltage are not depicted in FIG. 4. The operating phases are applied over the course of time “t.” FIG. 4 shows that the polarity “P” at each new operating phase is reversed and, at least over the course of numerous operating phases in the “DC voltage” mode, results in a temporal distribution of the DC-voltage polarities to the electrodes 20, 22 of the gas-discharge lamp 10 that approaches a symmetry. By this, a non-uniform burning of the electrodes 20, 22 is prevented.

During the operation in the “DC voltage” mode, it is re-checked in the control device 14 whether criteria for a return to the normal operating mode of the first operating mode of the gas-discharge lamp 10 have again been fulfilled. If this is the case, a switch is made to the normal operating mode with AC voltage, and the method according to the invention is completed.

A completely compensating DC-operating mode in terms of the positive and negative polarities is not yet ensured with this design because the temporal duration of the second operating mode can fluctuate. As is apparent from the example in FIG. 4, the time period, during which a negative polarity has been applied to the electrode 20, is substantially longer than the time period of a positive polarity applied to the electrode 20. The relationship of positive and negative polarities is oriented on the temporal distribution of external factors, which are triggered by the operation in the second operating mode.

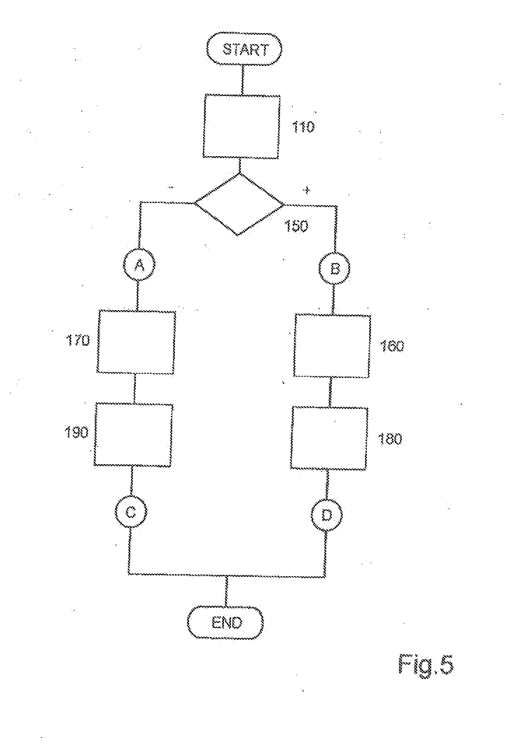

FIG. 5 shows a flow chart with a sequence of another, improved embodiment of the method according to the invention. This embodiment is distinguished in that the time period of the operation in the “DC voltage” mode, together with the respective polarities applied to the electrodes 20, 22, is detected and evaluated. The result of the evaluation determines the polarities for the subsequent operating phase in the DC mode.

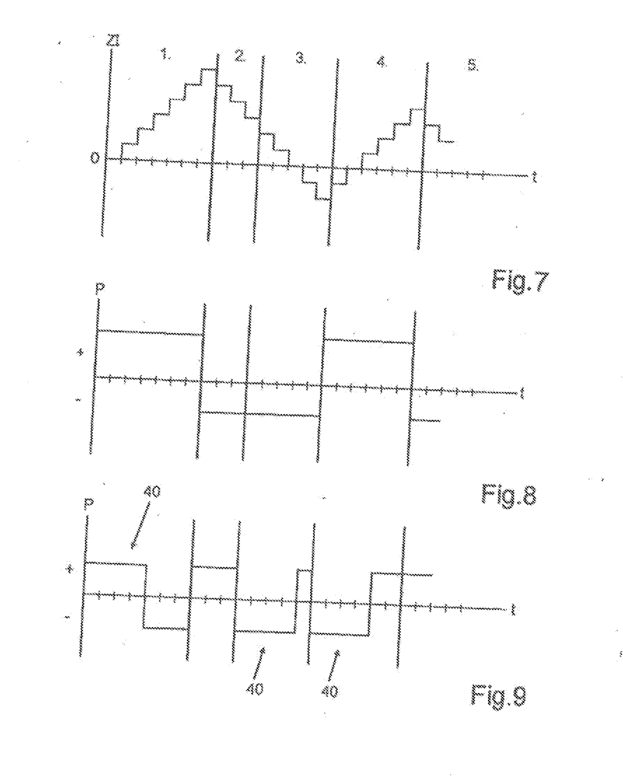

FIG. 7 shows, in an exemplary manner (starting from a base line), a course of a meter reading “ZI” for five operating phases in the DC mode, wherein intermediate AC-voltage normal operating phases are not depicted. With a positive polarity “P” at the electrode 20, the numbers increase. With a negative polarity “P” at the electrode 20, the numbers decrease. The respective applied polarity “P” at the electrode 20 (selected as an example) of the gas-discharge lamp 10 is shown in FIG. 8.

In query 100 in FIG. 5, it is checked (as has been explained in reference to FIG. 3) whether predefined threshold values have been exceeded, which indicate an exceeding of the internal temperature and/or the power loss to the control device 14. The ancillary conditions of the embodiment from FIG. 3 also apply in this case. If an exceeding of the threshold value has been detected, a switch is made in the control device 14 to the power-reduced second operating mode in the “DC voltage” mode.

For this, in query 150, a direction of the deviation of the meter reading in FIG. 7 from the base line is determined. If the deviation in FIG. 7 lies above the base line, then a negative polarity is applied to the electrode 20 in step 160 to count downward toward zero. If the reverse is the case, then a positive polarity is applied to the electrode 20 in step 170. In steps 180, 190, the meter reading is updated, in each case in accordance with the polarities and the metering rhythm. As a result, over the course of time “t,” following other operating phases in the “DC voltage” mode, and alternating about the base line is obtained.

The advantage of the embodiment of FIG. 5 is demonstrated, in particular, in the transition from the second to the third operating phase (compare FIGS. 7 and 8). In the second operating phase, a negative polarity is applied to the electrode 20 (compare FIG. 8), and the meter reading is counted downward. At the start of the third operating phase, the meter reading still lies above the base line. As a result, the gas-discharge lamp 10 in this embodiment is operated in the third operating phase of the component-protection operating mode, again with a negative polarity at the electrode 20, as was already the case in the second operating phase. The electrode is again operated with a positive polarity at the start of the fourth operating phase after the course first falls below the base line in FIG. 7.

FIG. 8 shows a substantially symmetrical distribution of the DC-voltage polarities at the electrode 20 of the gas-discharge lamp 10 with which a non-uniform burning of the electrodes 20, 22 can be more readily prevented than in the embodiment of FIG. 3 of the method. The operating phases with positive and negative polarities form a total, over the course of numerous operating phases, approaching an equal duration on a temporal basis. It is checked by the control device 14, over the course of the entire method in the “DC voltage” mode, whether the criteria for a normal operation of the gas-discharge lamp 10 are again present. If this is the case, a switch is made to the normal operating mode with AC voltage, and the method according to the invention is completed.

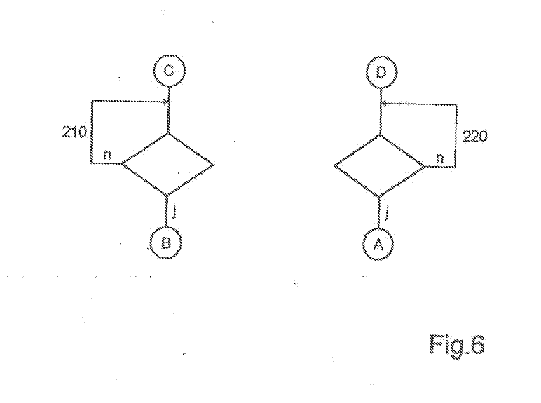

FIG. 6 shows a flow chart for a portion of another embodiment of the method according to the invention, wherein, for an entire sequence of this embodiment, the sequence from FIG. 6 must be combined with the sequence from FIG. 5. This embodiment, thus, represents a possible further development of the embodiment of FIG. 5. It is particularly distinguished in that, in addition to the characteristics of the embodiment of FIG. 5, an already elapsed time period of a continuing operating phase (with applied polarities remaining the same in the “DC voltage” mode) is monitored by the method and limited to a maximum value.

Without a limiting of this type and with a longer lasting and a contiguous DC-voltage operating phase, a one-sided burning of the electrodes in the gas-discharge lamp 10 can occur, which can shorten the life expectancy of the gas-discharge lamp 10. The monitoring can, for example, be implemented in the control device 14 by a meter, wherein, upon reaching a predefined temporal threshold value of the meter reading, the polarities at the electrodes 20, 22 are reversed. This reversal also occurs if the criteria for switching to the normal operating mode of the gas-discharge lamp 10 in the AC-voltage operating mode are not yet present (i.e., the current operating phase in the “DC voltage” mode is not yet completed).

In FIG. 6, in query 210, a time period of an ongoing operating phase having a negative polarity applied to the electrode 20, by way of example, is compared with the predefined threshold value. Alternatively, in query 220, a time period of a still-ongoing operating phase, having a positive polarity applied to the electrode 20, is compared with the predefined threshold value, depending on which path the method of FIG. 5 is currently in. The predefined threshold value can be the same in both cases. If the predefined threshold value has been reached, the gas-discharge lamp 10 is then operated with reversed polarities (see connector “A” or “B”).

With an assumed course of the five operating phases in the “DC voltage” mode from FIG. 7, FIG. 9 shows a course corresponding thereto of the polarity “P” applied to electrode 20, by way of example, with the application of the embodiment of FIG. 6 of the method according to the invention. The predefined threshold value is assumed in FIG. 9, in an exemplary manner, as value 4 for the meter reading. The first operating phase starts with a positive polarity at the electrode 20. After four meter cycles, the sum of which is indicated by 40, the predefined threshold value has been reached such that the method of the embodiment of FIG. 6 reverses the polarities at the electrodes 20, 22 even though the first operating phase in the “DC voltage” mode is not yet completed. At the start of the second operating phase, the polarities at the electrodes 20, 22 are again reversed such that a positive polarity is present at the electrode 20.

Upon completion of the second operating phase, the predefined threshold value is not reached. For this reason, the polarities are first reversed again (in accordance with the embodiment of FIG. 5) at the start of the third operating phase. A negative polarity is applied to the electrode 20. Upon completion of four meter cycles 40, the polarity at the electrode 20 is again reversed in the third operating phase even though the third operating phase in the “DC voltage” mode is not yet completed. The polarities at the electrodes 20, 22 are applied in a corresponding manner in the other operating phases.

Thus, by the embodiment of FIG. 6, in the “DC voltage” mode, on one hand, a temporally symmetrical distribution of the polarities at the electrode 20 of the gas-discharge lamp 10 is obtained over the course of numerous operating phases. On the other hand, by short phases of a one-sided-polarity application, an optimal life expectancy of the gas-discharge lamp is obtained.

The method step shown in FIG. 6 can also be used in the embodiment of FIG. 3 of the method according to the invention in that, with a one-sided-polarity application (upon reaching a predefined temporal threshold value), the polarities are reversed prior to the completion of the corresponding operating phase (not shown) to prevent a one-sided burning of the electrodes of the gas-discharge lamp here as well.

Another method for the operation of at least one gas-discharge lamp of a motor-vehicle headlamp is also conceivable. The at least one gas-discharge lamp is operated in a first operating mode at a comparatively higher power level and AC voltage and in a second operating mode, temporally limited, at a comparatively lower power level and DC voltage. Upon completion of a predetermined time period, the polarities at the electrodes of the gas-discharge lamp are reversed in the second operating mode. The reversals of the polarities occur, thereby, independently of a start of a new operating phase in the second operating mode and, thus, lead to a precisely symmetrical distribution of the polarities at the electrodes of the gas-discharge lamp.

The invention has been described above in an illustrative manner. It is to be understood that the terminology that has been used above is intended to be in the nature of words of description rather than of limitation. Many modifications and variations of the invention are possible in light of the above teachings. Therefore, within the scope of the appended claims, the invention may be practiced other than as specifically described above.

What is claimed is:

1. A method for operating at least one gas-discharge lamp (10) of a motor-vehicle headlamp, the method comprising steps of:
operating the at least one gas-discharge lamp (10) in a first operating mode with a comparatively higher power level and AC voltage and in a second operating mode in a temporally limiting manner with a comparatively lower power level and DC voltage, wherein a polarity of the DC voltage in changing from the first operating mode to the second operating mode is predetermined depending on the respective polarities of the DC voltage in at least one preceding operating phase of the second operating mode.

2. The method according to claim 1, wherein the first operating mode is a substantially normal operating mode and the second operating mode corresponds to a component-protection operating mode.

3. The method according to claim 1, wherein, at a start of each new one of the at least one operating phase of the second operating mode, the respective polarities of the DC voltage are reversed in comparison with the respective polarities in the at least one preceding operating phase of the second operating mode.

4. The method according to claim 1, wherein a temporal duration of each new one of the at least one operating phase of the second operating mode is determined and the respective polarities of the DC voltage are substantially symmetrically distributed over a course of a plurality of operating phases of the second operating mode.

5. The method according to claim 1, wherein a temporal duration of the at least one operating phase of the second operating mode is monitored and, upon exceeding an operating period defined as a maximum operating period, the respective polarities of the DC voltage are reversed.

6. The method according to claim 1, wherein a change from the first operating mode to the second operating mode is triggered depending on at least one of an internal temperature of a control unit (13) executing the method and a power loss to the control unit (13).

7. The method according to claim 6, wherein the change from the first operating mode to the second operating mode is triggered depending on at least one of a surrounding temperature of the control unit (13) and an electrical-system voltage for operating the at least one gas-discharge lamp (10).

8. A control unit (13) for operation of a gas-discharge lamp (10) of a motor-vehicle headlamp in a first operating mode with a comparatively higher power level and AC voltage and in a second operating mode in a temporally limiting manner with a comparatively lower power level and DC voltage, wherein the control unit (13) predetermines a polarity of the DC voltage during a change from the first operating mode to the second operating mode depending on the respective polarities of the DC voltage in at least one preceding operating phase of the second operating mode.

9. The control unit (13) according to claim 8, wherein the control unit (13) controls a sequence of a method for operating the at least one gas-discharge lamp (10).

10. The control unit (13) according to claim 8, wherein at least one sensor element (36, 38) for determining a temperature is dedicated to the control unit (13).
